(19) United States
(12) Patent Application Publication
(10) Pub. No.: US 2010/0161968 A1
(43) Pub. Date: Jun. 24, 2010

(54) Delivering content in digital postal envelope

(76) Inventor: James D. Pravetz, Sunnyvale, CA (US)

Correspondence Address: FISH & RICHARDSON P.C., P.O. Box 1022, MINNEAPOLIS, MN, 55440-1022, US

(21) Appl. No.: 10/841,292

(22) Filed: May 6, 2004

(51) Int. Cl. H04L 9/32; G06F 21/24; G06F 15/16

(52) U.S. Cl. 713/156; 726/28; 726/4; 713/176; 709/206

(57) ABSTRACT

Methods and apparatus, including computer program products, for generating and processing a digital document. The digital document includes private content that is accessible only upon a request for the private content, and presentation data that is accessible without the request for the private content. The presentation data defines a graphical representation of an addressed postal envelope that has a stamp side on which one or more intended recipients of the private content are represented as addressees.

### BACKGROUND

The present invention relates to the delivery of digital documents.

Traditional postal services deliver paper letters in sealed postal envelopes. A traditional postal envelope has a “seal side” where the envelope can be sealed, and a “stamp side” that carries the postage stamp. The addressee's name and address are specified on the stamp side.

For electronic mail (“e-mail”) services, computer applications often use a metaphor of the traditional postal envelope. Typically, the e-mail applications define envelope-like symbols to indicate electronic messages or mailing operations that include receiving or sending electronic messages. Outgoing mail is typically associated with small envelope-like icons that illustrate the stamp side of an envelope with a schematic stamp and a schematic, non-specific and illegible address. Such icons can be used as control icons for a “Send” operation, or to indicate mail messages waiting to be sent. For incoming e-mail messages that are received at a particular e-mail address, the owner of the particular e-mail address is presumed to be the intended recipient. Because the recipient is already known, instead of showing the envelope's stamp side with the address, the incoming mail is typically associated with envelope-like icons that illustrate only the envelope's seal side on which the traditional envelope can be opened by breaking the seal.

For delivering digital data to one or more destinations, multiple digital files can be attached to a single e-mail message. One or more of the attached files can be encrypted before attaching to the e-mail. The attached files can be identified in the e-mail message by standard icons. Multiple digital files can also be packaged into a single “Zip” file using applications such as WinZip® available from WinZip Computing, Inc. of Mansfield, Conn. Alternatively, the digital files can be embedded into a single document in Portable Document Format (“PDF”) using Adobe®Acrobat® applications available from Adobe Systems Incorporated of San Jose, Calif. To limit public access to the embedded files, the PDF document may be encrypted using standard cryptographic techniques.

### SUMMARY

A digital document includes private content and a graphical representation of a postal envelope that is addressed to one or more intended recipients of the private content. The graphical representation of the envelope can be publicly accessible, that is, accessible without restriction. Alternatively, the access to the envelope can be limited to a restricted set of users that are identified, for example, using a voucher system that authorizes access based on digital rights associated with the digital document.

In general, in one aspect, the invention provides a digital document. The digital document includes private content that is accessible only upon a request for the private content, and presentation data that is accessible without the request for the private content. The presentation data defines a graphical representation of an addressed postal envelope that has a stamp side on which one or more intended recipients of the private content are represented as addressees.

Particular implementations can include one or more of the following features. The presentation data can be accessible without restriction. The document can include multiple pages and the addressed envelope can be specified as the first page of the document. The presentation data can define one or more access control icons. At least one of the access control icons can be user selectable to generate the request for the private content. The presentation data can define the access control icons as icons on the stamp side of the postal envelope. At least one of the access control icons can identify accessing the private content as opening the envelope. The private content can include two or more content portions and the access control icons can include a separate access control icon to request access to each respective content portion. The stamp side of the envelope can include an address field in which the intended recipients are represented as addressees. The intended recipients can be explicitly specified in the address field. The representation of the intended recipients can depend upon an authorization by a voucher system. The intended recipients can be represented by a general address if the authorization by the voucher system fails. A sender of the document can be represented on the stamp side of the envelope. The sender can be represented in the upper left portion on the stamp side of the envelope. The sender can be represented only if authorized by a voucher system. The sender can be represented by a graphical representation of the sender's digital signature. The stamp side of the envelope can include a graphical representation of a postage stamp. The graphical representation of the postage stamp can be located in the upper right portion of the envelope. The postage stamp can represent a digital signature, such as the digital signature of a sender of the document, or a notarization of the document by a third party. The private content can be encrypted. The digital document can include security data that controls access to the encrypted private content. The security data can include data for obtaining a key that is required to access the encrypted private content.

In general, in another aspect, the invention provides methods and apparatus, including computer program products, for generating a digital document. The methods include encrypting private content, specifying security data that controls access to the private content, and specifying presentation data that defines a graphical representation of an addressed postal envelope on which one or more intended recipients of the private content are represented as addressees. A digital document is generated, where the generated document includes the encrypted private content, the security data and the presentation data.

Particular implementations include one or more of the following features. Specifying presentation data can include specifying presentation data that is accessible without restriction. Specifying presentation data can include defining an access control icon that is user selectable to request the permission to access the private content. User input can be received for specifying the intended recipients of the private content. The private content can be digitally signed, and specifying presentation data can include specifying a graphical representation of the digital signature on the stamp side of the envelope.

In general, in another aspect, the invention provides methods and apparatus, including computer program products, for processing digital documents. A digital document is received. The digital document includes private content and presentation data that defines a graphical representation of an addressed postal envelope that has a stamp side on which one or more intended recipients of the private content are represented as addressees. In a user interface, the graphical representation of the addressed postal envelope and an access control icon that is selectable to request access to the private content are presented. User input is received, where the user input selects the access control icon in the user interface to request access to the private content. Access is provided to the private content in response to the received user input.

Particular implementations can include one or more of the following features. Presenting the graphical representation of the postal envelope can include presenting publicly accessible portions of the addressed postal envelope. Providing access to the private content can include determining whether the user requesting access is authorized to access the private content, and access is provided to the private content only if the user is authorized. The access control icons can be defined in the received document.

The invention can be implemented to realize one or more of the following advantages. An addressed postal envelope can be presented when a user opens a digital document. From the address on the envelope, the user can quickly and easily identify the intended recipient or recipients of the document. Similar to traditional mail, the sealed and addressed envelope clearly suggests that the content of the document is private, not intended for the general public. If the document is accidentally delivered to an unintended destination, the address on the envelope will unambiguously warn the recipient about the accident and the private nature of the content. The recipient can recognize the delivery accident without accessing the private content. By using cryptographic techniques, the private content can be protected against unauthorized access. The addressed envelope can include an access control icon for requesting access to the private content of the document. The control icon will then associate accessing private content with the metaphor of opening a sealed and addressed envelope. This metaphor will be easily recognized by many users. A single document can have multiple addressees, and a separate access control can be provided for each of the addressees. With the respective access control, each respective addressee can easily identify the content portion for which he or she is the intended recipient. The different content portions can be differently encrypted to prevent accidental or intentional unauthorized access. The addressed envelope can include a digital signature to identify the sender and authenticate the private content. For example, the sender can digitally sign the document. To authenticate the document, the addressed envelope can also include a digital signature of a third party, such as a notarization service, a timestamp service or a mailing service delivering the document. The user identification can be performed without accessing the private content portion. By allowing public access to the addressed envelope, the information on the envelope can be used for search or organization without accessing the private information. By presenting the addressed envelope first, a user can make an informed decision about whether to open the envelope and access the content, which may be “contaminated” with computer viruses. If the envelope includes a digital signature, the user can determine whether the content can be trusted before accessing the content.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a schematic diagram illustrating a digital document including a graphical representation of an addressed envelope.

FIGS. 2A-2C are schematic diagrams illustrating exemplary graphical representations of addressed envelopes for digital documents.

FIG. 3 is a diagram illustrating an addressed envelope defined in an exemplary PDF document.

FIGS. 4 and 5 are schematic flow diagrams illustrating methods for generating digital documents including graphical representations of addressed envelopes.

FIG. 6 is a schematic flow diagram illustrating a method for accessing private content in a digital document.

FIGS. 7A and 7B are illustrating exemplary screen shots in a user interface configured to present digital documents including graphical representations of addressed envelopes.

Like reference numbers and designations in the various drawings indicate like elements.

### DETAILED DESCRIPTION

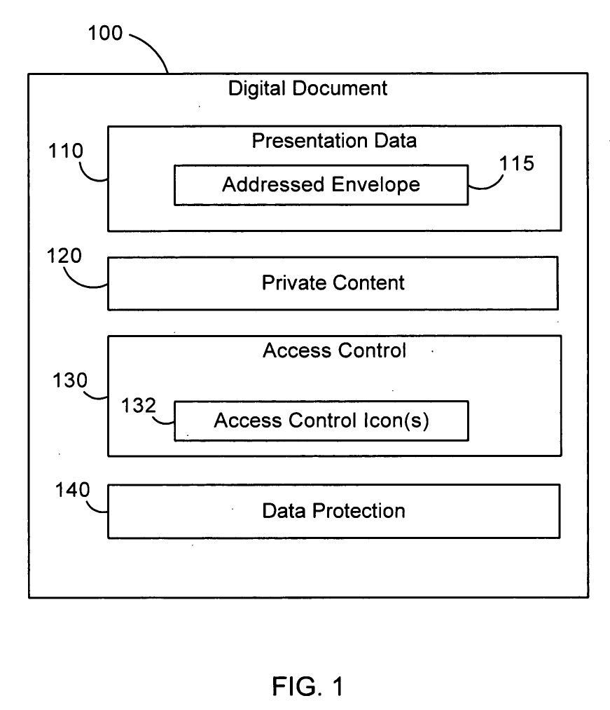

FIG. 1 illustrates a digital document 100. The digital document 100 is a collection of digital data that includes digital content for which a visual appearance or an audio presentation is defined. The digital content can represent text, graphics, audio, animation, video, or any other mode of presenting information. The digital document 100 can be implemented in a single file or in multiple files that are linked together by explicit references inside the files. In one implementation, the digital document 100 is a self-contained document whose content is defined without relying to other sources. For example, the digital document 100 can be a PDF document including multiple digital objects, such as document pages, images or any other digital object for which a visual appearance or an audio or video presentation is defined. In alternative implementations, the digital document 100 can be in any other format, such as Hyper Text Markup Language (“HTML”) or any format defined using Extensible Markup Language (“XML”).

The digital document 100 includes presentation data 110 and private content 120. The document 100 specifies an access control 130 for accessing the private content and data protection 140 to authenticate one or more portions of the digital document 100. In alternative implementations, the document 100 includes only the presentation data 110 and the private content 120.

The digital document 100 can be presented by a document management application that is a software application operable to present, process, edit or generate digital documents. When the digital document 100 is presented in a user interface by the document management application, the presentation data 110 is presented first without accessing the private content 120. In one implementation, the presentation data 110 is available to the public without restriction. Alternatively, access to the presentation data 110 can be limited, for example, by a voucher system.

The presentation data 110 defines a graphical representation of an addressed envelope 115. The envelope 115 identifies one or more addressees that are the intended recipients of the private content 120. The presentation data 110 defines the graphical representation of the addressed envelope 115 by pixel arrays, vector graphics or any other digital graphics objects. In one implementation, the entire graphical representation of the addressed envelope 115 is defined by the presentation data 110 in the document 100. Alternatively, one or more elements of the addressed envelope 115 can be specified by the document management application that opens the document 100. For example, the document management application can define the envelope's shape, and the presentation data 110 can define the address, a sender or a schematic postage stamp.

The presentation data 110 illustrates the stamp side of the envelope 115. On the stamp side, one or more addressees are identified as the intended recipients of the private content 120. The addressees can be specified by graphics objects or text using character encoding and fonts. The stamp side of the envelope can also include a schematic postage stamp or other elements that appear on a stamp side of a traditional postal envelope. For example, the addressed envelope 115 can include postmarks, a date stamp or an express label. In addition to the stamp side, the presentation data 110 can also specify an illustration of the seal side of the addressed envelope 115.

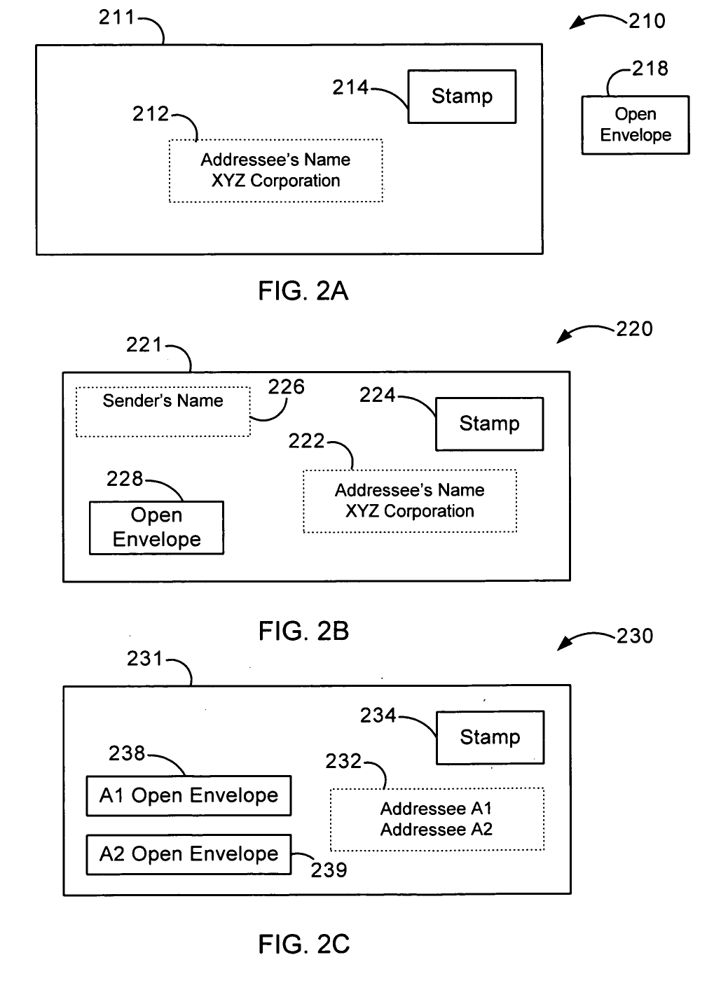

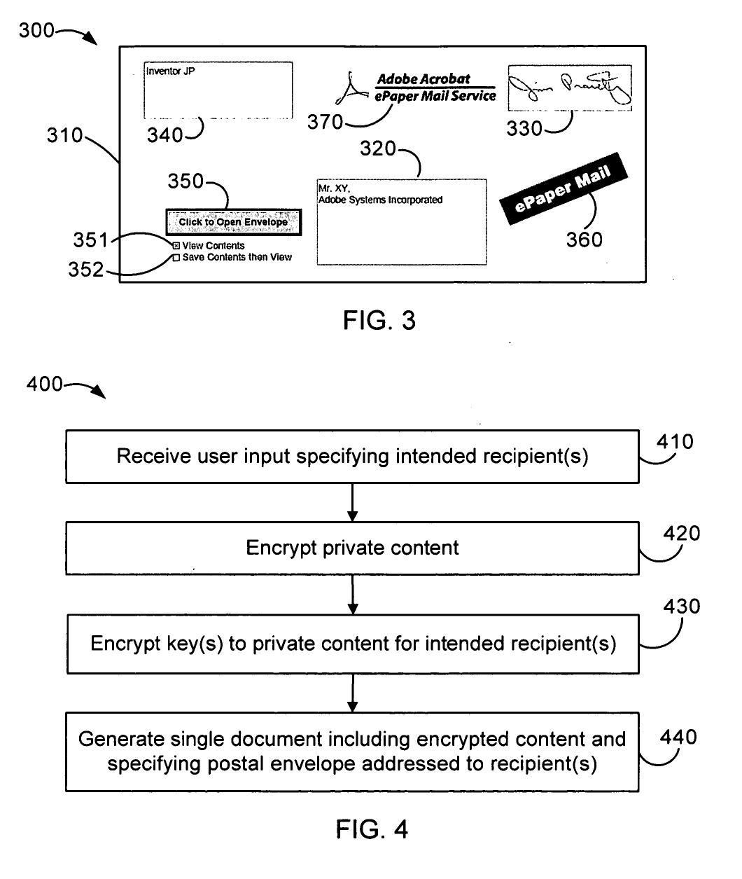

The addressed envelope 115 can be presented to a user in a user interface to indicate that the document 100 includes the private content 120, which is intended for use only by the addressees. Optionally, the presentation data 110 can also identify a sender of the document on the envelope 115. Or the envelope 115 can include a graphical representation of a digital signature. In one implementation, the digital signature is represented by the postage stamp. Alternatively, the digital signature can be represented by an object that is associated with the sender as identified on the envelope 115. Exemplary graphical representations of postal envelopes for digital documents are discussed below with reference to FIGS. 2A-3.

The private content 120 is accessible only after the addressed envelope 115 has been presented in the user interface. In one implementation, the document 100 includes multiple document pages, where the first page of the document illustrates the addressed envelope 115, and the private content 120 is illustrated on the document pages following the first page. Alternatively, the document management application or the document 100 can include explicit instructions to present the addressed envelope 115 before the private content 120. For example, the addressed envelope 115 can be presented simultaneously with a list including user selectable items to access one or more portions of the private content.

The private content 120 can be encrypted to prevent unauthorized access. In one implementation, the private content 120 is encrypted using one or more encryption filters. An encryption filter specifies an encryption algorithm, one or more algorithm parameters such as a length of a key used by the algorithm and mechanisms to obtain the key. For example, the key can be password protected or encrypted using a public key of the recipient. Each encryption filter is assigned to a separate portion of the private content 120, and encrypts that portion according to a corresponding key or cryptographic technique. Thus different keys can be specified for different portions of the private content 120. These keys can be provided only to the intended recipients so the different content portions can be accessed only by those recipients.

The access control 130 specifies how the private content 120 can be accessed. The access control 130 includes one or more access control icons 132. Each access control icon 132 is a small image or a dialog box that can be selected in a user interface to request access to the private content 120. To ensure that access is requested to the private content only after the addressed envelope 115 has been presented to the user, the access control icons 132 can be presented in the user interface along with the addressed envelope 115. The access control icons 132 can be located on the envelope 115 or next to the envelope 115. In alternative implementations, the access control icons 132 can be defined by the document management application receiving the document 100. For example, the application can include a general control panel that defines one or more selectable icons to access the private content.

The data protection 140 includes security information related to the private content 120, the sender of the document 100 or a third party authenticating the document 100. The data protection 140 can include one or more digital signatures of the sender, a mailing or a notary service to authenticate the content 120 or the identity of the sender. For each digital signature, the data protection 140 can include a signature value that is an encrypted digest of the data that is signed. The digest is defined by a mathematical function such that any change in the signed data alters the value of the function. Thus changes can be detected in the signed data. The signed data can include the private content 120 and a portion of the data protection 140 itself. The public presentation data 110 or the access control 130 can also be signed. In one implementation, the private content 120 is encrypted and the data protection 140 provides information about the encryption. For example, the data protection 140 can include security data to identify an encryption filter or a public key.

FIGS. 2A-2C illustrate exemplary graphical representations of an addressed envelope for a digital document that includes private content. For example, the exemplary graphical representations can be specified by the document 100 (FIG. 1).

FIG. 2A illustrates a first graphical representation 210 that represents a stamp side 211 of an addressed envelope and also includes an access control icon 218. The envelope's stamp side 211 includes an address field 212 and a schematic postage stamp 214. In the address field 212, the addressee's name and affiliation (in the example, “XYZ Corporation”) are specified. The address field 212 can be specified as a text window in which the addressee's name and affiliation are presented using character codes and fonts. Alternatively, the address field 212 can be a graphics object, such as a pixel array specifying an image of the addressee's name and affiliation. The address field 212 can be illustrated by a rectangle or by shading. The addressed field 212 can have a fixed size that is independent of a current size of the graphical representation 210 in a particular user interface. Thus the addressees' identity can easily be recognized even if the rest of the information on the stamp side 211 of the envelope is illegible. Alternatively, the address field 212 can have a variable size that scales with the current size of the graphical representation 210.

The schematic postage stamp 214 indicates that the graphical representation 210 illustrates the stamp side 211 of the addressed envelope. By presenting the postage stamp 214 simultaneously with the address field 212, the metaphor of a traditional postal envelope is reinforced. To further the metaphor, the stamp 214 is positioned in the upper right portion on the stamp side 211 and the address field 212 is positioned below the stamp 214, similar to the positions of the postage stamp and address on traditional postal envelopes.

The postage stamp 214 can illustrate a traditional postage stamp such as a postage stamp of the United States Postal Service (“USPS”). Alternatively, the postage stamp 214 can illustrate a symbol or an image that indicates a mailing or notary service or the identity of the sender. For example, the postage stamp 214 can illustrate a photograph or a hand written signature of the sender. Or the postage stamp 214 can indicate the document management application that generated the digital document. For example, the postage stamp 214 can illustrate a logo of the document management application.

In one implementation, the postage stamp 214 represents a digital signature of the mailing or notary service or the sender. The representation of the digital signature can also include a status representation for the digital signature. Alternatively, the document management application can specify a status icon to represent a current status for the digital signature. In a user interface, the postage stamp 214 or the status icon can also be selectable to request information about the digital signature. The status icon can be presented in visual association with the postage stamp 214. For example, the status icon can be presented in the vicinity of or overlapping the stamp 214.

The access control 218 is a graphical object that can be selected in a user interface to request access to private content in the digital document. The access control 218 explicitly refers to “opening the envelope” as a way to access the content. By associating the access control 218 with opening an addressed and sealed envelope, a user can easily recognize that the access control 218 requests access to private content that is intended only for the addressees identified in the address field 212.

The access control 218 can be defined by the digital document or by the document management application that received the document. In this example, the access control 218 is presented separately from the envelope's stamp side 211. Alternatively, the access control 218 or other control objects can be specified on the stamp side 211. For example, a control object can be specified by an icon presented on the stamp side 211. Alternatively, a “structural element” of the envelope, such as the address field 212 on the stamp side 211, can be defined as a control object that can be selected to request access to the private content.

FIG. 2B illustrates a second graphical representation 220 that represents a stamp side 221 of an addressed envelope. The envelope's stamp side 221 includes an address field 222, a schematic postage stamp 224, a sender field 226 and an access control 228. Similar to corresponding objects in the first graphical representation 210, the address field 222 specifies the addressee's name and affiliation, the stamp 224 indicates that the envelope's stamp side 221 is illustrated, and the access control 228 can be selected to request access to private content by opening the envelope. In the second graphical representation 220, however, the access control 228 is presented on the stamp side 221.

The sender field 226 specifies the sender of the document. To further the metaphor of the traditional postal envelope, the sender field is positioned in the upper left portion on the stamp side 221. The limits of the sender field 226 can be hidden or illustrated, for example by a rectangle or a shading of the sender field 226. The sender field 226 can be specified as a text window in which the sender's name is presented using character codes and fonts. Alternatively, the sender field 226 can be a graphics object, such as a pixel array specifying an image of the sender's name or any other graphics object that indicates the sender's identity. For example, the sender field 226 can include a graphical representation of the sender's hand-written signature. The sender field 226 can also represent a digital signature of the sender for which a signature status can be indicated in the sender field 226. Or the sender field 226 can be selectable to request information about the digital signature.

FIG. 2C illustrates a third graphical representation 230 that represents a stamp side 231 of an addressed envelope. The envelope's stamp side 231 includes an address field 232, a schematic postage stamp 234, a first access control 238 and a second access control 239. Similar to corresponding objects in the first and second graphical representations 210 and 220, the address field 232 specifies the intended recipients, the stamp 234 indicates that the envelope's stamp side 231 is illustrated, and the first and second access controls 238 and 239 can be selected to request access to private content by opening the envelope.

In the third graphical representation 230, the address field 232 identifies a first addressee (“A1”) and a second addressee (“A2”). The first access control 238 is defined to request access to content intended to the first addressee A1, and the second access control 239 is defined to request access to content intended to the second addressee A2. Thus each addressee can access the private content that is intended to that addressee without accessing private content that is intended to the other addressee. One way to prevent unauthorized access is by encrypting differently the content portions intended for the first and second addressees.

In alternative implementations, one or more elements in the graphical representations 210, 220 and 230 can be accessible upon authorization from a voucher system. For example, the sender's identity may be revealed only to users who are authorized by the voucher system. Or instead of explicitly specifying the addressee, the address field can include only a general indication such as the name of the addressee's corporation if the user who opens the document is not authorized by the voucher system.

FIG. 3 illustrates a graphical representation 300 of an addressed envelope that is defined in an exemplary PDF document. The graphical representation 300 represents a stamp side 310 of an addressed envelope. The envelope's stamp side 310 includes an address field 320, a schematic postage stamp 330, a sender field 340 and an access control 350. Similar to corresponding objects in the graphical representations of FIGS. 2A-2C, the address field 310 specifies the addressee, the stamp 330 indicates that the envelope's stamp side 310 is illustrated, the sender field 340 specifies the sender of the document, and the access control 350 can be selected to request access to private content by opening the envelope. In the graphical representation 300, the postage stamp 330 represents a digital signature of the sender and the access control 350 is presented on the stamp side 310.

The stamp side 310 also includes additional control icons 351 and 352, and graphical representations of a postal label 360 and a postal mark 370. The control icons 351 and 352 can be selected by a user to specify details for accessing the private content. The control icon 351 can be selected to view the private content without storing it on a storage device, and the control icon 352 can be selected to store the private content on the storage device before viewing the content. In alternative implementations, different or additional control icons can be presented on the stamp side 310 or another place separate from the graphical representation 300 of the envelope.

The postal label 360 and the postal mark 370 identify a type (“epaper Mail”) for the document and a document management application (“Adobe Acrobat”) that has generated the document. The postal label 360 and the postal mark 370 are presented in a form that furthers the metaphor of traditional postal envelopes. The postal label 360 resembles a traditional airmail label, and the postal mark 370 resembles that of a traditional express mail or priority mail service. In alternative implementations, different or additional marks or labels can be illustrated on the stamp side 310 of the envelope.

FIG. 4 illustrates a method 400 for generating a digital document, such as the digital document 100 (FIG. 1), which includes private content and a graphical representation of an addressed envelope to identify intended recipients of the private content. The method 400 can be performed by a system including a document management application that can encrypt one or more content portions in a document while allowing public access to other portions. In one implementation, the system includes an Adobe® Acrobat® application that generates a PDF document.

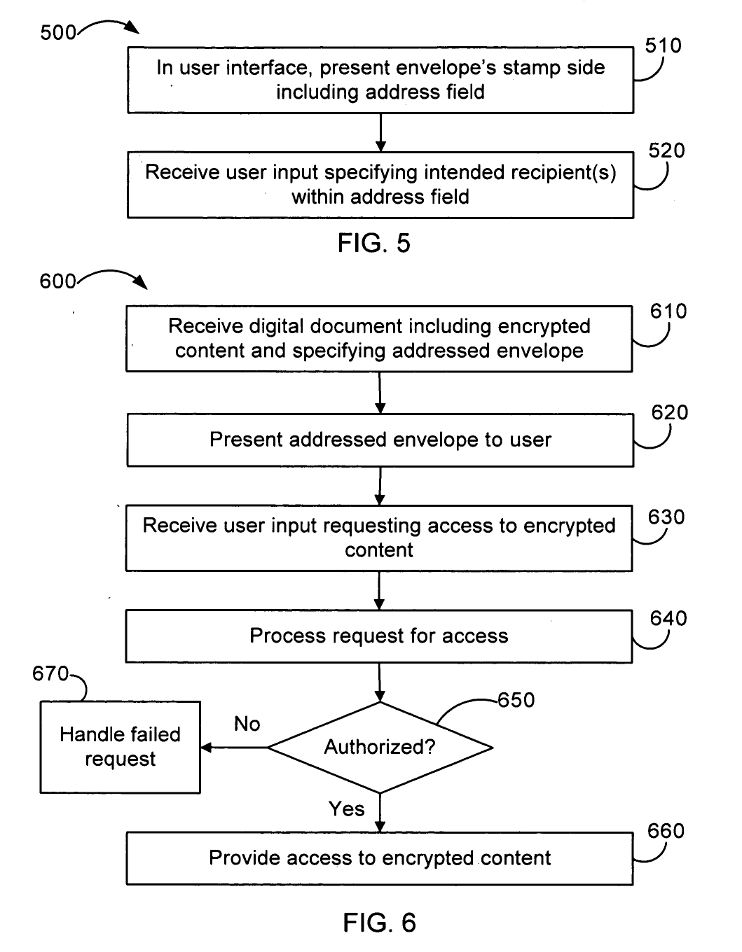

The system receives user input specifying one or more intended recipients for the private content (step 410). The intended recipients can be specified in any user interface. Specifying the recipients in a graphical user interface is further discussed below with reference to FIG. 5.

The system encrypts the private content (step 420) and a respective key to the private content for each intended recipient (step 430). The content and the keys can be encrypted using one or more standard encryption techniques. If different content portions are intended for different recipients, the system can use different encryptions for different content portions. For the encrypted content, the system can specify security data to identify a corresponding public key or cryptographic technique. In alternative implementations, the content can be encrypted using only a private key or other predefined encryption method. Thus no security data is required to identify a public key or an encryption method. In one implementation, the private content is digitally signed.

The system generates a single document that includes the encrypted content and a graphical representation of a postal envelope addressed to the specified recipients (step 440). For example, the graphical representation of the envelope can be similar to those illustrated in FIGS. 2A-3. The addressed postal envelope can be publicly accessible or one or more portions of it can be accessible only upon an authorization from a voucher or other authorization system. The generated document can also specify an access control for requesting access to the encrypted content. For example, the access control can be defined as part of the graphical representation of the addressed envelope. The access control can indicate that the encrypted content can be accessed by “opening” the envelope.

FIG. 5 illustrates a method 500 for specifying intended recipients of a digital document, such as the digital document 100 (FIG. 1). The method 500 can be performed by a system that includes a document management application.

In a graphical user interface, the system presents a graphical representation of a postal envelope's stamp side that includes an address field (step 510). For example, the graphical representation of the envelope can be similar to those illustrated in FIGS. 2A-3. In one implementation, the address field includes a dialog box to receive and present text. The dialog box can be empty or may include one or more predefined addresses.

The system receives user input specifying the intended recipients within the address field (step 520). If the address field includes a dialog box, the user can enter a name or an address of the intended recipients into the dialog box. If the dialog box includes predefined addresses, these can be deleted or edited by the user. Alternatively, the user interface can present a menu including multiple addresses, and the user can select one or more addresses from the menu. When the intended recipients are specified in the address field, the addressed envelope can be used as presentation data to specify the intended recipients of private content in the digital document.

FIG. 6 illustrates a method 600 for accessing private content in a digital document, such as the document 100 (FIG. 1). The method 600 can be performed by a system including a document management application that can decrypt encrypted portions of the digital document.

The system receives digital content that includes an encrypted content portion and specifies a graphical representation of an addressed envelope (step 610). The content portion can be encrypted by any cryptographic technology that is recognized by the system. The addressed envelope identifies one or more intended recipients of the digital document as the addressees of the envelope. The graphical representation of the envelope can be similar to those illustrated in FIGS. 2A-3.

In a user interface, the system presents the graphical representation of the addressed envelope to a user (step 620). The addressed envelope or portions of it can be accessible publicly or upon authorization from a voucher system. Without authorization, the corresponding portion can be hidden or replaced with other data. For example, the specific addressee can be hidden and replaced by a general address, such as an address where the document should be forwarded.

The graphical representation of the addressed envelope is the first portion of the document that is presented to the user. Because the envelope is addressed to the intended recipients, the user can easily identify the intended recipients of the document before trying to access the encrypted content. Thus the user can immediately close the document or send it to an intended recipient if the document was received or opened by accident.

The system receives user input requesting access to the encrypted content portion (step 630). Within the graphical representation of the addressed envelope or separately from it, the user interface presents a control icon that the user can select to request access to the encrypted content. The control icon can identify the access to the encrypted content as opening the envelope. Thus the user can easily recognize that the requested content is private and intended only to the addressees.

The system processes the request (step 640). For example, the system can request a password or a private key from the user to determine whether the user is authorized to access the encrypted content (decision 650). If the system determines that the user has the authorization (“Yes” branch of decision 650), the system provides access to the encrypted content (step 660). If the system determines that the user does not have the authorization (“No” branch of decision 650), the system does not provide access to the encrypted content. Instead, the system starts a predetermined procedure to handle the failed request (step 670). For example, the system may ask again for a password or a private key from the user, deny access, or may record the failed request for later processing.

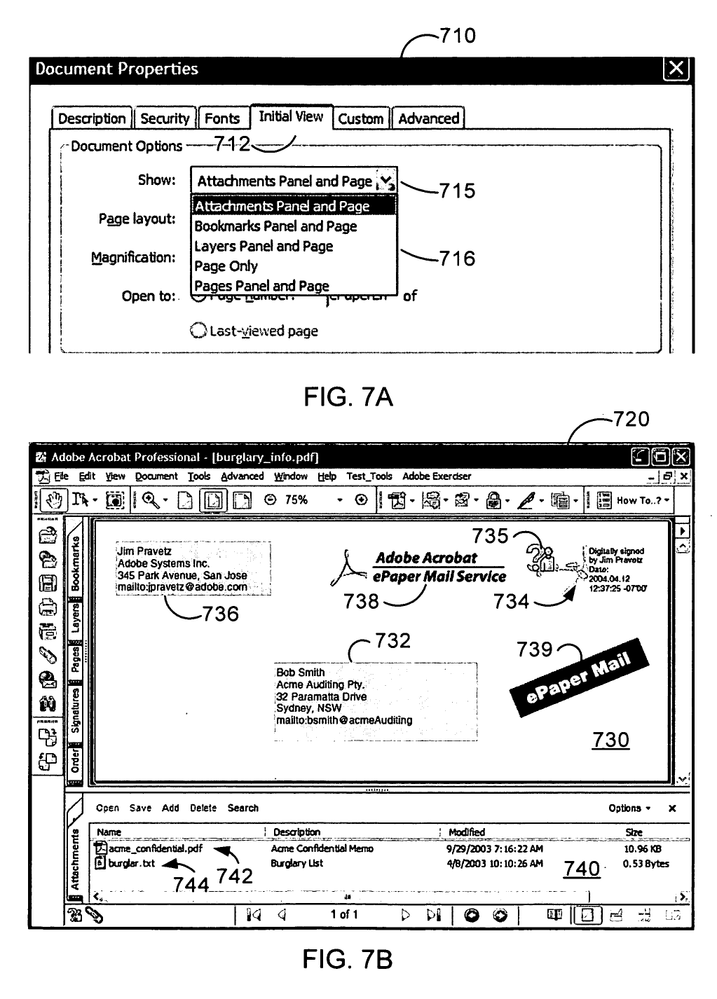

FIGS. 7A and 7B are illustrating exemplary screenshots from a user interface of a document management application that is configured to receive a document including private content and a graphical representation of an envelope addressed to the intended recipients of the private content.

FIG. 7A illustrates a first exemplary screenshot 710 in the user interface. In the first screenshot 710, the user interface includes an initial view panel 712 for specifying details of the user interface when it first opens a received document. The initial view panel 712 includes a dialog 715 for selecting from different presentation options for the initial view. In the dialog 715, the user can select which control panel will be presented with an initial page of the received document. The initial view panel 712 includes a menu 716 from which the user can select an initial view in which the initial page will be presented with an “Attachments” panel, a “Bookmarks” panel, a “Layers” panel, a “Pages” panel or without any control panel (“Page only”). In the example, the Attachments panel has been selected.

FIG. 7B illustrates a second exemplary screenshot 720 from the user interface. In the second screenshot 720, an initial view of a received document is presented according to the selection illustrated in the first screenshot 710. In the example, the received document's initial page is publicly accessible and includes a graphical representation of an addressed envelope 730. The addressed envelope 730 is presented concurrently with the Attachments panel 740, as selected in the dialog 715 from the menu 716.

The addressed envelope 730 is illustrated from the stamp side that includes an address field 732, a schematic postage stamp 734 and a sender field 736. Similar to corresponding objects in the graphical representations of FIGS. 2A-3, the address field 732 specifies the addressee, the stamp 734 indicates that the envelope's stamp side is illustrated, and the sender field 736 specifies the sender of the document. The stamp side of the envelope 730 also includes a postal mark 738 and a postal label 739 to identify that the received document is an ePaper Mail document generated by an Adobe® Acrobat® document management application.

In the addressed envelope 730, the postage stamp 734 represents a digital signature of the sender, and the document management application specifies a signature status icon 735 to indicate a current status for the digital signature represented by the stamp 734. The status icon 735 indicates that the identity of the signer is currently not known. Upon request, the document management application can try to authenticate the signature represented by the stamp 734, and update the status icon 735 according to the result of the authentication. Instead of using the status icon 735, the document management application can alter the graphical representation of the postage stamp 734 to indicate the current status of the digital signature.

The Attachments panel 740 presents an attachment list identifying digital objects that are attached to the envelope 730. In the example, the attachment list identifies a confidential memo 742 and a burglary list 744. Both the confidential memo 742 and the burglary list 744 include private content intended only to the addressee (“Bob Smith”) specified in the address field 732 of the envelope 730. The private content of the confidential memo 742 and the burglary list 744 can be accessed by selecting their respective representation in the attachment panel 740. Thus no control icons are presented on the stamp side of the envelope 730 to access the private content. Because the confidential memo 742 and the burglary list 744 are attachments to the addressed envelope 730, the user can easily recognize that these digital objects contain private data intended only to the addressee.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

By way of example, a printing device implementing an interpreter for a page description language, such as the PostScript® language, includes a microprocessor for executing program instructions (including font instructions) stored on a printer random access memory (RAM) and a printer read-only memory (ROM) and controlling a printer marking engine. The RAM is optionally supplemented by a mass storage device such as a hard disk. The essential elements of a computer are a processor for executing instructions and a memory. A computer can generally also receive programs and data from a storage medium such as an internal disk or a removable disk. These elements will also be found in a conventional desktop or workstation computer as well as other computers suitable for executing computer programs implementing the methods described here, which can be used in conjunction with any digital print engine or marking engine, display monitor, or other raster output device capable of producing color or gray scale pixels on paper, film, display screen, or other output medium.

The invention has been described in terms of particular embodiments. Other embodiments are within the scope of the following claims. For example, the steps of the invention can be performed in a different order and still achieve desirable results.

What is claimed is:

1-3. (canceled)

4. A machine-readable storage device embodying a digital document, comprising:
private content, including a first content portion and a second content portion, that is accessible only upon a request for the private content; and
presentation data that is accessible without the request for the private content, the presentation data defining a graphical representation of an addressed postal envelope that has a stamp side on which a first intended recipient and a second intended recipient of the private content are represented as addressees, wherein the presentation data defines a first access control icon for the first intended recipient and a second access control icon for the second intended recipient on the stamp side of the postal envelope, each of the first and second access control icons being user selectable to generate the request for the first content portion and the second content portion respectively.

5. (canceled)

6. The machine-readable storage device of claim 4, wherein:
each of the first and second access control icons identifies accessing the private content as opening the envelope.

7. (canceled)

8. The machine-readable storage device of claim 4, wherein:
the stamp side of the envelope includes an address field in which the first intended recipient and the second intended recipient are represented as addressees.

9. The machine-readable storage device of claim 8, wherein:
the first intended recipient and the second intended recipient are explicitly specified in the address field.

10. The machine-readable storage device of claim 8, wherein:
the representation of the first intended recipient and the second intended recipient depends upon an authorization by a voucher system.

11. The machine-readable storage device of claim 10, wherein:
the first intended recipient and the second intended recipient are represented by a general address if the authorization by the voucher system fails.

12. The machine-readable storage device of claim 4, wherein:
a sender of the document is represented on the stamp side of the envelope.

13. The machine-readable storage device of claim 12, wherein:
the sender is represented in the upper left portion on the stamp side of the envelope.

14. The machine-readable storage device of claim 12, wherein:
the sender is represented only if authorized by a voucher system.

15. The machine-readable storage device of claim 12, wherein:
the sender is represented by a graphical representation of the sender's digital signature.

16. The machine-readable storage device of claim 4, wherein:
the stamp side of the envelope includes a graphical representation of a postage stamp.

17. The machine-readable storage device of claim 16, wherein:
the graphical representation of the postage stamp is located in the upper right portion of the envelope.

18. The machine-readable storage device of claim 16, wherein:
the postage stamp represents a digital signature.

19. The machine-readable storage device of claim 18, wherein:
the postage stamp represents the digital signature of a sender of the document.

20. The machine-readable storage device of claim 16, wherein:
the postage stamp represents a notarization of the document by a third party.

21. The machine-readable storage device of claim 4, wherein the private content is encrypted.

22. The machine-readable storage device of claim 21, the digital document further comprising:
security data that controls access to the encrypted private content.

23. The machine-readable storage device of claim 22, wherein:
the security data includes data for obtaining a key that is required to access the encrypted private content.

24. A computer-implemented method for generating a digital document, the method comprising:
encrypting private content, including a first content portion and a second content portion;
specifying security data that controls access to the private content;
specifying presentation data that defines a graphical representation of an addressed postal envelope on which a first intended recipient and a second intended recipient of the private content are represented as addressees, wherein the presentation data defines a first access control icon for the first intended recipient and a second access control icon for the second intended recipient on the stamp side of the postal envelope, the first and second access control icons being user selectable to request permission to access the first content portion and the second content portion respectively; and
generating a digital document including the encrypted private content, the security data and the presentation data.

25. The method of claim 24, wherein:
specifying presentation data includes specifying presentation data that is accessible without restriction.

26. (canceled)

27. The method of claim 24, further comprising:
receiving user input specifying the first intended recipient and the second intended recipient of the private content.

28. The method of claim 24, further comprising:
digitally signing the private content, and wherein specifying presentation data includes specifying a graphical representation of the digital signature on the stamp side of the envelope.

29. A computer-implemented method for processing digital documents comprising:
receiving a digital document, the digital document including private content, having a first content portion and a second content portion, and presentation data that defines a graphical representation of an addressed postal envelope that has a stamp side on which a first intended recipient and a second intended recipient of the private content are represented as addressees;
in a user interface, presenting the graphical representation of the addressed postal envelope and a first access control icon for the first intended recipient and a second access control icon for the second intended recipient on the stamp side of the postal envelope that are selectable to request access to the first content portion and the second content portion respectively, wherein the presenting is performed by one or more data processing apparatus;
receiving user input selecting the first access control icon in the user interface to request access to the first content portion; and
providing access to the first content portion in response to the received user input.

30. The method of claim 29, wherein:
presenting the graphical representation includes presenting publicly accessible portions of the addressed postal envelope.

31. The method of claim 29, wherein providing access to the first content portion comprises:
determining whether the user requesting access is authorized to access the first content portion; and
providing access to the first content portion only if the user is authorized.

32. The method of claim 29, wherein the first access control icon and the second access control icon are defined in the received document.

33. A computer program product, encoded on a machine-readable storage device, for generating a digital document, operable to cause one or more data processing apparatus to perform operations comprising:
encrypting private content, including a first content portion and a second content portion;
specifying security data that controls access to the private content;
specifying presentation data that defines a graphical representation of an addressed postal envelope on which a first intended recipient and a second intended recipient of the private content are represented as addressees, wherein the presentation data defines a first access control icon for the first intended recipient and a second access control icon for the second intended recipient on the stamp side of the postal envelope, the first and second access control icons being user selectable to request permission to access the first content portion and the second content portion respectively; and
generating a digital document including the encrypted private content, the security data and the presentation data.

34. The computer program product of claim 33, wherein:
specifying presentation data includes specifying presentation data that is accessible without restriction.

35. (canceled)

36. The computer program product of claim 33, further operable to cause one or more data processing apparatus to perform operations comprising:
receiving user input specifying the first intended recipient and the second intended recipient of the private content.

37. The computer program product of claim 33, further operable to cause one or more data processing apparatus to perform operations comprising:
digitally signing the private content, and wherein specifying presentation data includes specifying a graphical representation of the digital signature on the stamp side of the envelope.

38. A computer program product, encoded on a machine-readable storage device, for processing digital documents, operable to cause one or more data processing apparatus to perform operations comprising:
receiving a digital document, the digital document including private content, having a first content portion and a second content portion, and presentation data that defines a graphical representation of an addressed postal envelope that has a stamp side on which a first intended recipient and a second intended recipient of the private content are represented as addressees;
in a user interface, presenting the graphical representation of the addressed postal envelope and a first access control icon for the first intended recipient and a second access control icon for the second indented recipient on the stamp side of the postal envelope that are selectable to request access to the first content portion and the second content portion respectively;
receiving user input selecting the first access control icon in the user interface to request access to the first content portion; and
providing access to the private content in response to the received user input.

39. The computer program product of claim 38, wherein:
presenting the graphical representation includes presenting publicly accessible portions of the addressed postal envelope.

40. The computer program product of claim 38, wherein providing access to the first content portion comprises:
determining whether the user requesting access is authorized to access the first content portion; and
providing access to the first content portion only if the user is authorized.

41. The computer program product of claim 38, wherein the first access control icon and the second access control icon are defined in the received document.

42. A system comprising:
one or more processors;
at least one computer readable medium storing a software program product, tangibly embodied in an information carrier, for generating a digital document;
the software program product comprising instructions operable to cause the one or more processors to perform operations comprising:
encrypting private content, including a first content portion and a second content portion;
specifying security data that controls access to the private content;
specifying presentation data that defines a graphical representation of an addressed postal envelope on which a first intended recipient and a second intended recipient of the private content are represented as addressees, wherein the presentation data defines a first access control icon for the first intended recipient and a second access control icon for the second intended recipient on the stamp side of the postal envelope, the first and second access control icons being user selectable to request the permission to access the first content portion and the second content portion respectively; and
generating the digital document including the encrypted private content, the security data and the presentation data.

43. The system of claim 42, wherein:
specifying presentation data includes specifying presentation data that is accessible without restriction.

44. (canceled)

45. The system of claim 42, the software program product further comprising instructions operable to cause one or more processors to perform operations comprising:
receiving user input specifying the first intended recipient and the second intended recipient of the private content.

46. The system of claim 42, the software program product further comprising instructions operable to cause one or more processors to perform operations comprising:
digitally signing the private content, and wherein specifying presentation data includes specifying a graphical representation of the digital signature on the stamp side of the envelope.

47. The system of claim 42, wherein:
in a user interface, presenting the graphical representation of the addressed postal envelope and the first access control icon that is selectable to request access to the first content portion;
receiving user input selecting the first access control icon in the user interface to request access to the first content portion; and
providing access to the first content portion in response to the received user input.

48. The system of claim 47, wherein:
presenting the graphical representation includes presenting publicly accessible portions of the addressed postal envelope.

49. The system of claim 47, wherein providing access to the first content portion comprises:
determining whether the user requesting access is authorized to access the first content portion; and
providing access to the first content portion only if the user is authorized.

50. The system of claim 47, wherein the first access control icon and the second access control icon are defined in the electronic document.

51. The machine-readable storage device of claim 4, wherein the first content portion is encrypted with a first encryption filter according to a corresponding first key corresponding to the first intended recipient and the second content portion is encrypted with a second encryption filter according to a corresponding second key provided to the second intended recipient.

52. The method of claim 24, wherein encrypting the private content comprises encrypting the first content portion with a first encryption filter according to a corresponding first key corresponding to the first intended recipient and encrypting the second content portion with a second encryption filter according to a corresponding second key provided to the second intended recipient.

53. The method of claim 29, wherein the first content portion is encrypted with a first encryption filter according to a corresponding first key corresponding to the first intended recipient and the second content portion is encrypted with a second encryption filter according to a corresponding second key provided to the second intended recipient.

54. The computer program product of claim 33, wherein encrypting private content, comprises encrypting the first content portion with a first encryption filter according to a corresponding first key corresponding to the first intended recipient and encrypting the second content portion with a second encryption filter according to a corresponding second key provided to the second intended recipient.

55. The computer program product of claim 38, wherein the first content portion is encrypted with a first encryption filter according to a corresponding first key corresponding to the first intended recipient and the second content portion is encrypted with a second encryption filter according to a corresponding second key provided to the second intended recipient.

56. The system of claim 42, wherein encrypting private content, including a first content portion and a second content portion comprises encrypting the first content portion with a first encryption filter according to a corresponding first key corresponding to the first intended recipient and encrypting the second content portion with a second encryption filter according to a corresponding second key provided to the second intended recipient.
